(19) United States
(12) Patent Application Publication
(10) Pub. No.: US 2002/0114888 A1
(43) Pub. Date: Aug. 22, 2002

(54) Method of applying a coating to a concrete surface and product related thereto

(76) Inventor: Charles T. Magliocca, Tacoma, WA (US)

Correspondence Address: Robert B. Hughes, Hughes Law Firm, PLLC, Suite 201, 2801 Meridian St., Bellingham, WA, 98225, US

(21) Appl. No.: 10/077,015

(22) Filed: Feb. 15, 2002

Related U.S. Application Data
(60) Provisional application No. 60/269,252, filed on Feb. 15, 2001.

(51) Int. Cl. B05D 3/02; B05D 1/04

(52) U.S. Cl. 427/314; 427/475; 427/189

(57) ABSTRACT

A method of applying a protective coating to a concrete or concrete-related substrate. The substrate is heated, and then electrostatically-charged coating powder is deposited onto the substrate with the coating powder coalescing into a coherent layer. Then the substrate and the coating are cooled to form the protective layer. The moisture content of the concrete or concrete-related material is sufficiently low so that bubbles or separation does not occur, and sufficiently high so that the electrostatically-charged particles will adhere to the substrate.

### RELATED APPLICATIONS

This application claims priority of 60/269,252, filed Feb. 15, 2001.

### BACKGROUND OF THE INVENTION

a) Field of the Invention

The present invention relates to a method for applying a protective and/or decorative coating to a concrete surface, more particularly where particles are electrostatically applied onto said concrete or concrete-related surface to form the coating, and also relates to the products resulting therefrom.

b) Background Art

There is an existing method where electrostatically charged coating particles (i.e. powder) are applied to a metal substrate to form a coating. This can be done, for example, to inhibit the formation of rust or other degradation of the surface, and also, if desired, to provide a decorative surface. The electrostatically charged particles (i.e. the coating powder) will adhere to the metal material, thus enabling an effective coating layer to be formed.

Typically the metal substrate is heated to a temperature of approximately about 400° F. With the metal substrate being grounded, a “gun” is used to discharge the coating powder onto the surface of the metal substrate. The gun which accomplishes this is arranged so that the coating powder is passed through an electric field to provide it with an electrostatic charge, and then sprayed it against the surface, where it coalesced in a coherent layer, which later hardens into a protective coating.

### SUMMARY OF THE INVENTION

The method of the present invention provides a protective coating for a concrete or concrete-related substrate. There is first provided a concrete or concrete-related substrate which is heated to a temperature sufficiently high to cause moisture in the concrete substrate to turn to a gaseous form to be emitted from the concrete substrate.

Then there is deposited a layer of electrostatically-charged coating powder on a surface area of the concrete or concrete-related substrate to cause said coating powder to coalesce into a coherent layer on the surface of the substrate.

Then the substrate with the layer of coating powder thereon is cooled to form the layer of coating powder into a hardened protective layer on the substrate.

The method is characterized in that the moisture content of the concrete or concrete-related substrate is brought to a sufficiently low level so that during the application of the coating powder bubbles or separation does not occur in the layer of the coating powder coalescing on the substrate. Yet the moisture content of the concrete or concrete-related substrate so that the electrostatically-charged coating powder adheres to the surface to the concrete or concrete-related substrate.

In one embodiment, the substrate comprises predominantly concrete. In another embodiment, the substrate comprises a composite of concrete and another material. In yet another embodiment, the substrate comprises a fiber cement substrate.

Also, as an option heat is applied to the coating powder and the substrate during the time that the coating powder is on the substrate as a layer to cause a layer to properly form the protective layer on the concrete or concrete-related product.

Also, the present invention includes products comprising a concrete or concrete-related substrate with a protective and/or decorative coating made from the above recited method.

### DETAILED DESCRIPTION OF THE PREFERRED EMBODIMENT

In one preferred embodiment of the present invention, a concrete or concrete-related substrate is provided, and this can been in the form of a concrete or concrete-related panel, slab, or some other concrete product. Within the broader scope of the present invention, the concrete or concrete-related material could be solely concrete or a composite made of concrete and some other material, such as fiber or fibrous material, or other material. One such material is provided by James Hardy Building Products, and the generic name given to this product is “fiber cement board”. Three pages of specification sheets are attached to this application as Attachment A and are labeled 1a, 1b, and 1c. These contain information about the board itself, and also the paint materials that are recommended for being applied to the fiber cement board. This Attachment A represents a prior art method.

In the prior art, these concrete or concrete-related materials are provided with a protective coating by applying conventional paint products as described in the above-noted publication. However, it has been found that in accordance with the present invention, if the concrete or concrete-related substrate is heated and if electrostatically-charged coating powder is deposited on the concrete or concrete-related substrate under the right processing conditions, a very effective protective coating will result.

With regard to the coating powder which is applied, to the best knowledge of the applicant, most conventional coating powders which are sold for electrostatically depositing on a metal substrate would work in the present invention. One of these which has been found to be effective in the present invention is one which is marketed by Dupont under the mark “SILVADILLO”. Attached to this application as Attachment B is a five-page specification of the same.

In the following text, the concrete or concrete-related substrate which is suitable for use in the present invention will simply be called the “concrete panel” or “the concrete substrate”, with the understanding that this substrate could take different forms and shape, and that the term “concrete” will include substrate made up entirely of concrete, or could be made of concrete and other materials, as indicated above.

In the method of the present invention, the concrete or other concrete substrate is heated to a desired temperature, which desirably can be about 250° F. or higher. However, this temperature can be made lower or higher depending on the particular situation, the coating powder used, etc.

The moisture content of the concrete substrate is significant, and prior to depositing the coating powder, the heating is usually continued for a desired period of time to lower the moisture content in the concrete panel or other product to a desired level. After the concrete panel or other item is at the proper level of moisture content and at a sufficiently high temperature (e.g. 250° F.), the particulate material is discharged through a spray gun in a manner that the coating powder is electrostatically charged and directed onto the surface of the concrete panel or other concrete product to form a coherent layer. After this the panel is cooled, so that the coating material has been formed into a hardened continuous layer of the coating material properly bonded to the concrete substrate.

It would be possible to formulate the coating powder to provide various selected colors to form an attractive finish.

With regard to bringing the concrete panel or other product which is to be coated to the proper moisture content, it is surmised that the moisture content should be sufficiently low so that as the coating powder is applied to form the coating, the moisture does not boil out through the applied layer of material and thus cause bubbles or otherwise damage the same. On the other hand, it is surmised that there should be a certain amount of moisture content so that the electrostatically-charged particles would adhere to the concrete surface. More specifically, it is surmised that the electrostatically-charged particles have the polarizing effect on the moisture that is available on the concrete so that there is proper adherence of the electrostatically-charged particles. However, regardless of the validity or invalidity of this theory, it has been found in actual practice of the process that the proper adhering of the coating powder is accomplished and the protective layer is properly formed.

With the particles in the heated environment coalescing to form a coating, if needed, additional heat could be applied to the coating layer and substrate. The panel with the coating layer is cooled to normal room temperatures. The coated concrete (or concrete composite) product can then be used in a manner that the panel or other product would normally be used, such as being used as a building panel or other uses.

It is obvious that various modifications could be made in the present invention without departing form the basic teachings thereof.

[image]

[image]

[image]

[image]

[image]

[image]

[image]

[image]

Therefore I claim:

1. A method of providing a protective coating for a concrete or concrete-related substrate, said method comprising:
a) heating said concrete or concrete-related substrate to a temperature sufficiently high to cause moisture in the concrete substrate to turn to a gaseous form to be emitted from the concrete substrate;
b) depositing a layer of an electrostatically-charged coating powder onto a surface area of said concrete or concrete-related substrate to cause said coating powder to coalesce into a coherent layer on the surface of the substrate;
c) cooling said substrate with the layer of coating powder thereon to form into a hardened protective layer on the substrate;
d) said method being characterized in that the moisture content of the concrete or concreterelated substrate is at a sufficiently low level so that during the application of the coating powder bubbles or separation does not occur in the layer of the coating powder coalescing on the substrate, and yet the moisture content of the concrete or concrete-related substrate is sufficiently high so that the electrostatically-charged coating powder adheres to the surface of the concrete or concrete-related substrate.

2. The method as recited in claim 1, wherein said substrate comprises predominately concrete.

3. The method as recited in claim 1, wherein said substrate comprises a composite of concrete and another material.

4. The method as recited in claim 1, wherein said substrate comprises a fiber cement substrate.

5. The method as recited in claim 1, wherein heat is applied to the powder coating and the substrate during the time that the powder coating is on the substrate as a layer to cause said layer to properly form the protective layer on the concrete or concrete-related substrate.

6. A product made in accordance with the method of claim 1, wherein said substrate has a layer of a hardened protective coating thereon, made in accordance with the method of claim 1.
